(19) United States
(12) Patent Application Publication
(10) Pub. No.: US 2017/0020152 A1
(43) Pub. Date: Jan. 26, 2017

(54) PROCESS FOR PRODUCING LACTOSE-FREE DAIRY PRODUCTS (I)

(71) Applicant: DMK Deutsches Milchkontor GmbH, Zeven (DE)

(72) Inventors: Sven-Rainer Döring, Zeven (DE); Jan Aschemann, Zeven (DE); Thorben Oehlckers, Buchholz (DE)

(21) Appl. No.: 15/196,853

(22) Filed: Jun. 29, 2016

(30) Foreign Application Priority Data
Jul. 25, 2015 (EP) 15 178 393.3

(51) Int. Cl. A23C 9/12; A23C 9/15; A23C 9/142

(52) U.S. Cl. CPC A23C 9/1206; A23C 9/1422; A23C 9/1427; A23C 9/1512

(57) ABSTRACT

A process for producing lactose-free dairy products is suggested, comprising the following steps:
(a) Hydrolysis of a starting milk while adding lactase;
(b) Nanofiltration of the hydrolysis product for producing a first permeate P1 and a first retentate R1;
(c) Reverse osmosis or nanofiltration of the first permeate P1 for producing a second permeate P2 and a second retentate R2;
(d) Mixing the first retentate R1 with such an amount of the second permeate P2 and the retentate R2 that a standardized dairy product is obtained, the content of proteins and minerals of which correspond to the one of the starting milk.

### FIELD OF THE INVENTION

The invention is in the field of lactose-free dairy products and relates to the production of dairy products with reduced, but defined, lactose content and a largely identical mineral composition in comparison with the starting milk, which may be converted into lactose-free products without changing the taste profile of the starting milk.

### STATE OF THE ART

During their breastfeeding period, newborn mammals create the enzyme lactase, which breaks down the disaccharide milk sugar into the sugar types D-galactose and D-glucose, which are metabolically usable. In the process of natural weaning from breast milk, the activity of lactase drops to about 5-10% of its activity at the time of birth. This applies to humans and all other mammals alike. Only in populations that had been consuming dairy for a long time a mutation became predominant which has the effect that a sufficient amount of lactase is continued to be created in adulthood (lactase persistence). It is assumed that this is caused by the higher lactase activity which provided these groups with a selective advantage (mineral substances, nutritional value).

In the case of deficient lactase activity in humans, unbroken milk sugar moves as far as the colon where it is absorbed and fermented by intestinal bacteria. Lactic acid as well as methane and hydrogen are formed as fermentation products. The gases cause, inter alia, bloating, and the osmotically active lactic acid causes an increased flow of water into the bowels (osmotic diarrhea).

In Asia and Africa, the lack of lactase persistence or lactose intolerance affects the majority of the adult population (90% or more), in Western Europe, Australia, and North America it is 5-15% (in the case of fair-skinned people). In Germany, 15-25% of the total population are estimated to suffer from a milk sugar intolerance. The reason for a lactose intolerance is a congenital enzyme deficiency, in which the relevant enzymes are missing that break down milk sugar into its components and decompose it. In the past years, at least the awareness that there is a context between the symptoms mentioned and the presence of lactose, particularly in dairy products, has strongly increased. This resulted in a great demand for products that are low in lactose, or better, lactose-free.

Various processes are known in the state of the art, by means of which lactose is either separated from dairy products and further processed as a by-product, or decomposed by adding enzymes as appropriate.

The subject matter of EP 1503630 B1 (VALIO) is, for example, a process for producing lactose-free products, wherein the starting milk is initially subjected to ultrafiltration. The first permeate obtained herein is nanofiltered, in the process of which lactose is discharged via the second retentate, and the monovalent salts (sodium, potassium) enter into the second permeate. The latter is concentrated by means of reverse osmosis and the third retentate such obtained is admixed to the first retentate again before subjecting it to hydrolysis in order to enzymatically decompose lactose. The process, however, has two substantial disadvantages: it is impossible to control the lactose content of the retentate which is hydrolyzed, as it automatically adjusts to a very low value as a result of the ultrafiltration conditions. As a result, only small amounts of sugar are available for breaking down during hydrolysis, so that a lactose-free milk is obtained, which, however, is much less sweet and has a less pleasing taste than the starting milk. Further, this process allows only alkaline salts to be fed back into the milk. In order to more or less achieve the taste profile of the original milk, divalent salts from other sources must be added again. In sum, in any case, a product is obtained which only approximately corresponds to the desired taste profile of the original milk.

A similar path is suggested in EP 2207428 B1 (ARLA): here, milk is also initially subjected to ultrafiltration, whereby the permeate is then nanofiltered. The permeate of nanofiltration is mixed with the retentate of ultrafiltration and is subsequently hydrolyzed. However, this process has the same disadvantages as the Valio process with respect to the taste profile of the resulting products.

It is therefore the object of the present invention to provide a lactose-free dairy composition on the basis of whole milk, skimmed milk, or standardized milk, which typically contains between 4 and 5% by weight lactose, which, however, possesses the same or substantially the same mineral composition as the starting milk, so that its taste profile corresponds to the one of the starting milk.

### SUMMARY OF THE INVENTION

The subject-matter of the invention is a process for producing lactose-free dairy products, comprising the following steps:
(a) Hydrolysis of a starting milk while adding lactase;
(b) Nanofiltration of the hydrolysis product for producing a first permeate P1 and a first retentate R1;
(c) Reverse osmosis or nanofiltration of the first permeate P1 for producing a second permeate P2 and a second retentate R2;
(d) Mixing the first retentate R1 with such an amount of the second permeate P2 and the retentate R2, or the concentrate K1 each so that a standardized dairy product is obtained, the content of proteins and minerals of which corresponds to the one of the starting milk.

In a first particular embodiment, in step (a) such an amount of lactase is applied that the amount of lactose contained in the product is completely broken down into glucose and galactose. This means that all further process steps are performed using an already lactose-free milk, the mineral concentration and composition of which must still be adapted to the ones of the starting milk.

In an alternative second embodiment, the process comprises the following further step:
(e) Hydrolysis of the standardized dairy product of step (d) while adding such an amount of lactase that the residual amount of lactose still contained in the product is completely broken down into glucose and galactose.

This embodiment of the invention takes effect in case that in step (a) an amount of lactase has been applied which is just not sufficient to break down the total amount of lactose.

Surprisingly, it was found that the process of the invention fully complies with the described requirement profile. In doing so, the milk is initially subjected to hydrolysis, in which one molecule of lactose is broken down into one molecule of glucose and one molecule of galactose, respectively. Subsequently, the hydrolysis product is separated into a protein fraction and a carbohydrate fraction, with the latter initially present in concentrated form and then added to the protein fraction while adding water in such an amount (“standardization”) that the protein and mineral composition of the starting milk is obtained again. Studies on the relative sweetening power (rS) of different carbohydrates based on saccharose (cf. Noeske, 1996) showed that both glucose (rS=64) and galactose (rS=60) each had about twice the sweetening power of lactose (rS=30). Preferably, the content of glucose and galactose is thus set to a value with which the sweetness of the starting milk is achieved. As a result of adding the milk's own salts to the milk instead of other salts during standardization, after hydrolysis, in sum, a product is obtained which is lactose-free, but does not differ from the starting milk in its composition, thus having the same taste impression.

Products containing less than 0.1 wt % and, preferably, less than 0.01 wt % lactose are understood to be lactose-free.

### BRIEF DESCRIPTION OF THE DRAWING

The present invention will be described in greater detail with reference to the accompanying drawing which schematically illustrates a flow chart of the present invention.

### DESCRIPTION OF THE INVENTION

### Hydrolysis

Suitable starting materials may be whole milk, skimmed milk, or standardized milk with a lactose content in the range of about 3 to about 5 wt % and, preferably, about 4 to about 4.5 wt %. Lactose belongs to the group of disaccharides and consists of the two molecules D-galactose and D-glucose, which are bonded by a β-1,4-glycosidic bond.

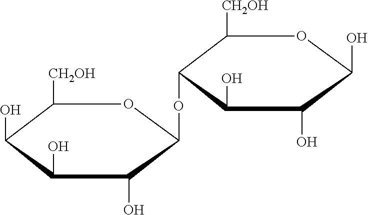

In order to perform a decomposition into the two sugar components, the enzyme lactase (also referred to as LPH or LCT) is added to lactose. Hydrolysis is, preferably, performed in a stirred tank with a continuous inlet and outlet as well as a dosing device for adding the enzyme and a valve arranged at the bottom of the reactor for discharging the deactivated enzynne which deposits in the course of time. It has proved to be advantageous to use an efficient enzyme concentration of about 180,000 to 250,000 FCC units of lactase per kg of lactose to be hydrolyzed, and to perform the reaction at temperatures in the range of about 4 to about 65° C. and, preferably, in the range of 20 to 30° C. and with a slightly acid pH value of about 5 to 6.

1. Nanofiltration

In the second process step, the hydrolysis product is separated into a protein fraction and a carbohydrate fraction.

Nanofiltration belongs to the filtration processes in the field of membrane technology, by means of which macromolecular substances and small particles may be separated from a medium and concentrated. Depending on the degree of separation, microfiltration, ultrafiltration and nanofiltration are distinguished. If the exclusion limit (also called “Cut-off”) is 100 nm or more, this is referred to as microfiltration. If the exclusion limit is in the range between 2 to 100 nm, this is referred to as ultrafiltration. In the case of nanofiltration the exclusion limit is below 2 nm. Each of these cases is a purely physical, i.e. mechanical, membrane separation process functioning according to the principle of mechanical size exclusion: all particles in the fluids larger than the membrane pores are retained by the membrane. The driving force in both separation processes is the differential pressure between the inlet and the outlet of the filter surface, which is between 0.1 and 40 bar.

The exclusion limits of nanofiltration membranes are also specified in the form of NMWC (Nominal Molecular Weight Cut-Off, also called MWCO, Molecular Weight Cut Off, unit: Dalton). It is defined as the minimum molecular weight of globular molecules which are retained to 90% by the membrane. In practice, the NMWC should be at least 20% lower than the molecular mass of the molecule to be separated. Further qualitative statements about filtration may be made using the flux (water value) (transmembrane flux or passage rate). In an ideal case, it behaves proportionally to the transmembrane pressure and reciprocally to the membrane resistance. These quantities are determined both by the properties of the membrane used and also by concentration polarization and the fouling which may occur. The passage rate is based on 1 m² membrane surface. Its unit is 1/(m² h bar).

In a preferred embodiment of the process of the invention, nanofiltration is performed while adding such an amount of diafiltration water that a first retentate with a dilution factor of about 1 to about 10 is obtained and, preferably, about 3 is obtained. Preferably, the diafiltration water is taken from the second permeate P2 of the subsequent reverse osmosis step.

Open-pore membranes with a pore diameter in the range of about 100 to about 1,000 and, preferably, of about 500 to about 800 Dalton have proved to be particularly suitable for nanofiltration.

The material of the filter surface may be made of stainless steel, polymer materials, ceramics, aluminum oxide or textile fabric. There are different forms of filter elements: cartridge filters, flat membranes, spiral wound membranes, bag filters and hollow fiber membrane modules, which are all principally suitable within the meaning of the present invention. However, spiral wound membranes made of polymer materials, or cartridge filters made of ceramics or aluminum oxide are preferably used, whereby the first embodiment has been proved particularly suitable for ultrafiltration and the second one for nanofiltration.

Nanofiltration within the meaning of the present invention may be performed “hot” or “cold”, i.e. in the temperature range of about 4 to about 55° C. It is, however, preferable to operate at temperatures in a low range from about 4 to about 25° C. and, particularly, about 6 to about 15° C.

### Reverse Osmosis

The first permeate P1 of nanofiltration is practically free of proteins, however, it contains glucose, galactose and minerals in a concentration that is practically unchanged relative to the one of the starting milk. In the following reverse osmosis step, the amount of these two components is concentrated.

Reverse osmosis is a physical method for concentrating substances that are dissolved in liquids, wherein the pressure of the natural osmosis process is reversed. The medium in which the concentration of a particular substance is to be reduced is separated by a semipermeable membrane from the medium in which the concentration is to be increased. The latter is subjected to a pressure that must be higher than the pressure created by the osmotic requirement to establish a concentration equilibrium. In doing so, the molecules of the solvent may travel against their “natural” osmotic expansion direction. By this method they are pressed into the compartment where dissolved substances are present in a lower concentration.

The osmotic membrane which only allows the carrier liquid (solvent) to pass, retaining the dissolved substances (solute), must be able to withstand these high pressures. If the difference in pressure more than equalizes the osmotic gradient, the solvent molecules will pass through the membrane just as through a filter, while the remaining molecules are retained. In contrast to a classic membrane filter, osmosis membranes do not possess continuous pores. Ions and molecules rather travel through the membrane by diffusing through the membrane material.

The osmotic pressure increases with increasing difference in concentration. If the osmotic pressure becomes equal to the pressure applied, the process will stop. Then an osmotic equilibrium is present. A continuous discharge of the concentrate may prevent this. In the case of the concentrate outlet, the pressure is either controlled by a pressure regulator or used by a pressure exchanger in order to create the pressure required in the inlet of the system. Pressure exchangers very effectively reduce the operating cost of a reverse osmosis plant by recovering energy. The energy input per cubic meter of water is 4 to 9 kWh. Preferably, the concentration factor in the process of the invention is about 2.5 to about 5 and, particularly, about 3 to about 4.

Crystallization (precipitation) of the solutes in the membranes must be prevented. This may be achieved by the addition of anti-scaling means or acids. Herein, anti-scaling means are polymer compounds on the basis of phosphate or maleic acids, which envelope the forming crystals, thus preventing the forming of crystalline precipitations on the membrane. However, cleaning of the membrane may still remain necessary. Additionally, in order to prevent the membrane from damage, filters may be set up upstream. A fine mesh filter may prevent mechanical damage, an activated carbon filter may prevent chemical damage (e.g., by chlorine).

During reverse osmosis, a second permeate is obtained, which substantially only represents diafiltration water which can be fed back into the nanofiltration step, and a retentate containing carbohydrates and minerals, which has a dry matter content in the order of about 10 to about 15 wt % after optional further concentration (e.g., by evaporation).

2. Nanofiltration

Alternatively, also a second nanofiltration step may be performed instead of the reverse osmosis step. In doing so, however, membranes with a pore diameter of about 150 to about 200 Dalton are, preferably, used. In their composition, permeate and retentate are very similar to the products of reverse osmosis; the nanofiltration permeate merely has a higher content of monovalent salts. Also this permeate may be used as a diafiltration medium.

Mixing

The mixing step serves the production of a standardized dairy product, from which lactose is subsequently completely removed by further hydrolysis if still required. In doing so, defined amounts of carbohydrates (glucose and galactose) and minerals are added to the protein-rich first retentate obtained in the first step. It is particularly intended to obtain a product which has a correspondingly adapted sugar concentration relative to the starting milk in order to obtain the same sweetness. Also the addition of minerals is pursued with the goal of readjusting the original salt concentration and salt composition in order to maintain the taste impression of the original milk.

In a specific embodiment, the process of the invention is, therefore, further characterized in that
(i) such an amount of the second retentate R2 is added to the first retentate R1 that a concentration of glucose and galactose of together about 1.0 to about 3.5 wt %, preferably, about 1.5 to about 3.0 wt %—based on the resulting standard milk is obtained and/or
(ii) such an amount of the second permeate P2 is added to the first retentate R1 that a mineral concentration of about 0.6 to about 1.0 wt %—based on the resulting standard milk—is obtained, and/or
(iii) such an amount of the second permeate P2 is added to the first retentate R1 that by this dilution a protein concentration of about 3.5 to about 4.0 wt %—based on the resulting standard milk—is obtained.

### REFERENCE SIGNS IN THE FIGURE

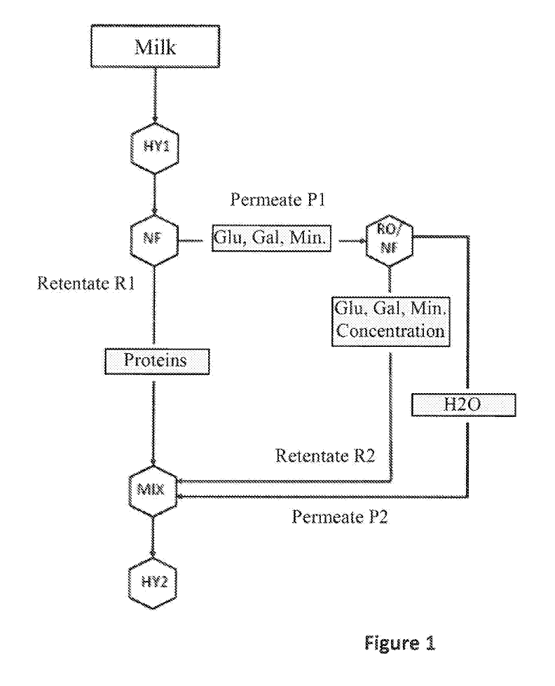

The process of the invention is schematically summarized in FIG. 1. Here, the abbreviations mean:
NF=Nanofiltration
RO=Reverse osmosis
MIX=Mixing
HY=Hydrolyse
Glu=Glucose
Gal=Galactose
Min=Minerals

### EXAMPLES

### Example 1

100 kg milk of the following composition

| MILK | Amount [wt %] |
|---|---|
| Lactose | 4.0 |
| Proteins | 3.5 |
| Minerals | 0.8 |

was set to pH=6 in a stirred tank at 25° C., and such an amount of lactase was added that a concentration of about 200,000 FCC units/kg lactose was obtained. After a hydrolysis time of about 3 hours a product was obtained, having the following composition:

| HYDROLOYSIS | |
|---|---|
| PRODUCT | Amount [wt %] |
| Lactose | <0.1 |
| Glucose | 2.0 |
| Galactose | 2.0 |
| Proteins | 3.5 |
| Minerals | 0.8 |

The hydrolysis product was subsequently subjected to a first nanofiltration step at 10° C. using an open-pore membrane with a pore size of 600 Dalton while adding diafiltration water. The dilution factor was 3, whereby a protein-rich first retentate R1 was obtained as an intermediate product having the following composition:

| RETENTATE R1 | Amount [wt %] |
|---|---|
| Lactose | <0.1 |
| Glucose | 2.0 |
| Galactose | 2.0 |
| Proteins | 11.0 |
| Minerals | 0.8 |

Simultaneously, a first permeate P1 was obtained, which was low-protein, having the following composition:

| PERMEATE P1 | Amount [wt %] |
|---|---|
| Lactose | <0.1 |
| Glucose | 2.0 |
| Galactose | 2.0 |
| Proteins | <0.1 |
| Minerals | 0.4 |

The first permeate P1 was subjected to reverse osmosis at 10° C. with a concentration factor of 3.5. In doing so, a second permeate P2 was obtained, which practically only consisted of water. The second carbohydrate-rich retentate R2 obtained during reverse osmosis had a dry matter content of about 13 wt % and the following composition:

| RETENTATE R2 | Amount [wt %] |
|---|---|
| Lactose | <0.1 |
| Glucose | 6.0 |
| Galactose | 6.0 |
| Proteins | <0.1 |
| Minerals | 1.2 |

Subsequently, such an amount of carbohydrate-rich retentate R2 and of permeate P2 were added to the retentate R1 that a standardized milk of the following composition resulted:

| STANDARD MILK | Amount [wt %] |
|---|---|
| Lactose | <0.1 |
| Glucose | 1.0 |
| Galactose | 1.0 |
| Proteins | 3.5 |
| Minerals | 0.8 |

The standardized milk thus had the same content of proteins and the same amount and composition of minerals as the starting milk, however, it only contained the corresponding amount of glucose and galactose with which the same sweetening power of the starting milk was obtained. In this manner, a lactose-free milk was obtained, having the same sweetness and the same taste profile as the original milk.

### Example 2

100 kg milk of the following composition

| MILK | Amount [wt %] |
|---|---|
| Lactose | 4.0 |
| Proteins | 3.5 |
| Minerals | 0.8 |

was set to pH=6 in a stirred tank at 25° C., and such an amount of lactase was added that a concentration of about 200,000 FCC units/kg lactose was obtained. After a hydrolysis time of about 3 hours a product was obtained, having the following composition:

| HYDROLOYSIS | |
|---|---|
| PRODUCT | Amount [wt %] |
| Lactose | <0.1 |
| Glucose | 2.0 |
| Galactose | 2.0 |
| Proteins | 3.5 |
| Minerals | 0.8 |

The hydrolysis product was subsequently subjected to a first nanofiltration step at 10° C. using an open-pore membrane with a pore size of 600 Dalton while adding diafiltration water. The dilution factor was 3, whereby a protein-rich first retentate R1 was obtained as an intermediate product having the following composition:

| RETENTATE R1 | Amount [wt %] |
|---|---|
| Lactose | <0.1 |
| Glucose | 2.0 |
| Galactose | 2.0 |
| Proteins | 11.0 |
| Minerals | 0.8 |

Simultaneously, a first permeate P1 was obtained, which was low in proteins, having the following composition:

| PERMEATE P1 | Amount [wt %] |
|---|---|
| Lactose | <0.1 |
| Glucose | 2.0 |
| Galactose | 2.0 |
| Proteins | <0.1 |
| Minerals | 0.4 |

The first permeate P1 was subjected to a second nanofiltration step at 10° C. using a membrane with a pore size of 150 Dalton with a concentration factor of 3.5. In doing so, a second permeate P2 was obtained, which practically only consisted of water and alkaline salts. The second carbohydrate-rich retentate R2 obtained from nanofiltration had a dry matter content of about 13 wt % and the following composition:

| RETENTATE R2 | Amount [wt %] |
|---|---|
| Lactose | <0.1 |
| Glucose | 6.0 |
| Galactose | 6.0 |
| Proteins | <0.1 |
| Minerals | 1.2 |

Subsequently, such an amount of carbohydrate-rich retentate R2 and of permeate P2 was added to the first retentate R1 that a standardized milk of the following composition resulted:

| STANDARD MILK | Amount [wt %] |
|---|---|
| Lactose | <0.1 |
| Glucose | 1.0 |
| Galactose | 1.0 |
| Proteins | 3.5 |
| Minerals | 0.8 |

The standardized milk thus had the same content of proteins and the same amount and composition of minerals as the starting milk. The total amount of carbohydrates (glucose+galactose) was 2 wt %. In this manner, a lactose-free milk was obtained, having the same sweetness and the same taste profile as the original milk.

1. Currently Amended A process for producing lactose-free d products, comprising the following steps:
(a) hydrolyzing a starting milk while adding lactase;
(b) subjecting the hydrolyzation product of step (a) to nanofiltration for producing a first permeate P1 and a first retentate R1, with an open-pore nanofiltration membrane having a pore diameter n the range of about 100 to about 1,000 Dalton;
(c) subjecting said first permeate P1 to reverse osmosis for producing a second permeate P2 and a second retentate R2; and
(d) mixing said first retentate R1 with such an amount of the second permeate P2 and the second retentate R2 each such that a standardized dairy product is obtained, the content of proteins and minerals of which corresponds to the one of the starting milk.

2. The process of claim 1, comprising applying in step (a) an amount of lactase such that the amount of lactose contained in the product is completely broken down into glucose and galactose.

3. The process of claim 1, further comprising the step of:
(e) hydrolyzing said standardized dairy product of step (d) while adding an amount of lactase such that the residual amount of lactose still contained in the product is completely broken down into glucose and galactose.

4. The process of claim 1, comprising applying whole milk, skimmed milk, or standard milk as starting milk.

5. The process of claim 1, comprising applying a starting milk having a lactose content in the range of about 3 to about 5 wt %.

6-7. (canceled)

8. The process of claim 1, wherein said nanofiltration is performed with a volume dilution factor in the range of 1 to about 10.

9. The process of claim 1, wherein said nanofiltration is performed at temperatures n the range of about 4 to about 25° C.

10. The process of claim 1, wherein said reverse osmosis is performed with a concentration factor of about 2.5 to about 5.

11. (canceled)

12. The process of claim 1, comprising adding an amount of the second retentate R2 to the first retentate R1 such that a concentration of glucose and galactose of together of about 1.0 to about 3.5 wt %—based on the resulting standard milk—is obtained.

13. The process of claim 12, comprising adding an amount of the second retentate R2 to the first retentate R1 such that a concentration of glucose and galactose together of about 1.5 to about 3.0 wt %—based on the resulting standard milk—is obtained.

14. The process of claim 1, comprising adding an amount of the second permeate P2 to the first retentate R1 such that a mineral concentration of about 0.6 to about 1.0 wt %—based on the resulting standard milk—is obtained.

15. The process of claim 1, comprising adding an amount of the second permeate P2 to the first retentate R1 such that by this dilution, a protein concentration of about 3.5 to about 4.0 wt %—based on the resulting standard milk—is obtained.
